(19) United States
(12) Patent Application Publication
(10) Pub. No.: US 2014/0310698 A1
(43) Pub. Date: Oct. 16, 2014

(54) APPARATUS AND METHOD FOR UPGRADING FIRMWARE OF MOBILE TERMINAL

(71) Applicant: Pantech Co., Ltd., Seoul (KR)

(72) Inventors: Jin-Suk LEE, Seoul (KR); Hyun Seok KIM, Seoul (KR); Young-Bi YU, Seoul (KR)

(73) Assignee: Pantech Co., Ltd., Seoul (KR)

(21) Appl. No.: 14/242,195

(22) Filed: Apr. 1, 2014

(30) Foreign Application Priority Data
Apr. 10, 2013 (KR) 10-2013-0039542

(51) Int. Cl. G06F 9/445

(52) U.S. Cl. CPC G06F 8/65
USPC 717/168

(57) ABSTRACT

A method for upgrading firmware of a mobile terminal includes dividing a first firmware into a plurality of first firmware sections, storing a copy of at least one of the first firmware sections in the mobile terminal, loading a second firmware divided into a plurality of second firmware sections, determining whether at least one of the second firmware sections has incurred an error, loading the stored copy of the first firmware section corresponding to the second firmware section if the second firmware section is determined to have incurred an error, and executing the first firmware section or the second firmware section for executing at least one of a kernel and an operating system of the mobile terminal. The method further includes replacing at least one of the second firmware sections having an error with a corresponding replacement second firmware section if an error is determined to have occurred.

### CROSS-REFERENCE TO RELATED APPLICATION

This application claims priority from and the benefit under 35 U.S.C. §119(a) of Korean Patent Application No. 10-2013-0039542, filed on Apr. 10, 2013, the entire disclosure of which is incorporated herein by reference for all purposes.

### BACKGROUND

1. FIELD

The following description relates to an apparatus and a method for upgrading software, and more particularly, to upgrading of firmware of a mobile terminal.

2. DISCUSSION OF THE BACKGROUND

Consumer electronics usually provide limited simple operational capabilities. As users desire consumer electronics with more variety and more complex operational capabilities, microcontrollers or microprocessors are implemented in consumer electronics. In particular, as the concept of a smart device is introduced to simpler consumer electronic devices, microcontrollers are mounted on various consumer electronic devices. A consumer electronic device including a microcontroller stores firmware in a memory for operating the consumer electronic device. Upgrading of firmware is often used to improve operational capability or to solve problems. In particular, a smart device, such as a smartphone, often upgrades firmware in order to improve its operational capability, thereby improving the performance of the smart device.

A smart device often upgrades firmware using a wired method, such as a universal serial bus (USB) cable, or using a wireless method, such as firmware over-the-air (FOTA). The upgrading of firmware may refer to a process of updating or replacing existing firmware with the new firmware, which is received in a wired or wireless manner. The existing firmware and the new firmware are stored in a storage unit.

However, in a process of upgrading firmware, an error may occur for some reasons, for example, low power or communication interference. When an error occurs, new firmware may not be appropriately installed and existing firmware may be damaged. When an error occurs in the process of upgrading the firmware, a system has to enter a firmware download mode again. However, when a program to drive the system, such as a bootloader, is damaged before the system enters the firmware download mode, a critical fault may occur and the smart device may not be normally booted and may be unable to re-install the firmware.

However, it is difficult to predict such an error or completely prevent such an error from occurring during a process of upgrading firmware due to an environmental factor or an artificial factor. Also, when an error occurs in a process of upgrading firmware and a critical fault occurs, a user may not be able to directly solve the problem and may be inconvenienced by having to request a maker of the smart device to repair the smart device.

### SUMMARY

Exemplary embodiments of the present invention provide an apparatus and a method for upgrading firmware of a mobile terminal.

Additional features of the invention will be set forth in the description which follows, and in part will be apparent from the description, or may be learned by practice of the invention.

Exemplary embodiments of the present invention provide a method for upgrading firmware of a mobile terminal having a processor, the method including dividing, using the processor, a first firmware into a plurality of first firmware sections; storing a copy of at least one of the first firmware sections in the mobile terminal; loading a second firmware divided into a plurality of second firmware sections; determining whether at least one of the second firmware sections has incurred an error; loading the stored copy of the first firmware section corresponding to the second firmware section if the second firmware section is determined to have incurred an error; and executing the first firmware section or the second firmware section for executing at least one of a kernel and an operating system of the mobile terminal.

Exemplary embodiments of the present invention provide a method for upgrading firmware of a mobile terminal having a processor, the method including dividing, using the processor, a first firmware into a plurality of first firmware sections; storing a copy of at least one of the first firmware sections in the mobile terminal; upgrading the first firmware with a second firmware, the second firmware divided into a plurality of second firmware sections; determining whether an error occurs when upgrading; and replacing at least one of the second firmware sections having an error with a corresponding replacement second firmware section if an error is determined to have occurred.

Exemplary embodiments of the present invention provide an apparatus to upgrade firmware of a mobile terminal having a processor, the apparatus including a control unit to divide a first firmware into a plurality of first firmware sections; a storage unit to store a copy of at least one of the first firmware sections, and to store a second firmware divided into a plurality of second firmware sections; and a management unit to load at least one of the second firmware sections, to determine whether the loaded second firmware section incurred an error, to load the stored copy of the first firmware section corresponding to the second firmware section if the second firmware section is determined to have incurred an error, and to execute the first firmware section or the second firmware section for executing at least one of a kernel and an operating system of the mobile terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an apparatus to upgrade firmware of a mobile terminal according to an exemplary embodiment of the present invention.

FIG. 2 is a detailed block diagram illustrating a firmware storage unit of FIG. 1 according to an exemplary embodiment of the present invention.

FIG. 3 is a flowchart illustrating a method for upgrading firmware of a mobile terminal according to an exemplary embodiment of the present invention.

FIG. 4 is a flowchart illustrating a booting process of FIG. 3 according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

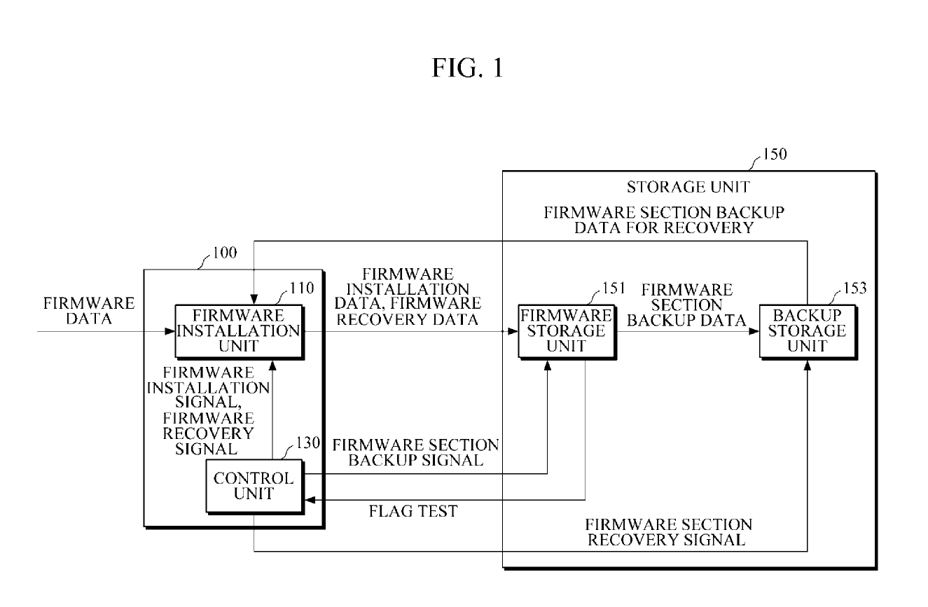

FIG. 1 is a block diagram illustrating an apparatus to upgrade firmware of a mobile terminal according to an exemplary embodiment of the present invention.

Referring to FIG. 1, the apparatus includes a management unit 100 and a storage unit 150.

The management unit 100 includes a firmware installation unit 110 and a control unit 130. The storage unit 150 includes a firmware storage unit 151 and a backup storage unit 153.

The firmware installation unit 110 may install or upgrade a new firmware based on a firmware installation signal or recover a backup firmware based on a firmware recovery signal received from the control unit 130. The firmware installation unit 110 may receive new firmware data in a wired manner, such as a universal serial bus (USB) cable, or in a wireless manner, such as firmware over-the-air (FOTA). When the firmware installation unit 110 receives a firmware installation signal from the control unit 130, the firmware installation unit 110 may install the received new firmware data in the storage unit 151.

When the firmware installation unit 110 receives a firmware recovery signal for a specific firmware section or all firmware sections from the control unit 130, the firmware installation unit 110 may receive a backed up firmware section data of the existing or previously installed firmware for recovery from the backup storage unit 153 of the storage unit 150. The firmware installation unit 110 may recover a backed up firmware section, which may be a copy of the existing or previously installed firmware before the attempted upgrade, that may be stored in the firmware storage unit 151. The backup firmware section data, which may be data that backs up a copy the firmware that is installed and normally executed before the attempted upgrade, is obtained by dividing the copy of the existing firmware into two or more sections and storing the two or more sections in the firmware storage unit 151. The firmware installation unit 110 may recover some or all sections of the backed up firmware according to the received backup firmware section data.

Before the firmware installation unit 110 installs new firmware installation data in the firmware storage unit 151 to upgrade to the new firmware, the control unit 130 may transmit a firmware section backup signal to the firmware storage unit 151. In an example, upgrading of the firmware may include, without limitation, at least one of downloading, loading, and installing of the new firmware, and replacing the firmware existing before the upgrade, or existing firmware, with the new firmware, i.e., the new firmware may be the same as, a previous version of, a new version of, or an upgraded version of the current firmware. The firmware section backup signal may refer to a control command to divide a copy of the existing firmware into two or more sections and back up the divided sections of the existing firmware, which may correspond to the firmware currently installed and operating before upgrading to the new firmware. The control unit 130 may divide a copy of the existing firmware and transmit the firmware section backup signal to the firmware storage unit 151 so that the firmware storage unit 151 may back up a copy of the existing firmware divided into two or more sections.

The firmware may be divided into two or more firmware sections according to, without limitation, a unit of operation, or a unit of division and/or installation. For example, a copy of the firmware installed in a mobile terminal may be divided into a bootloader section, a kernel section, and an operating system (OS) section. Also, the bootloader section may be further divided into two or more bootloader sub-sections according to at least one of an operation, a size, an objective, and the like. However, aspects of the invention are not limited thereto, such that the firmware section may be divided according to other factors or units.

Since a firmware or a firmware section is divided into two or more sections or sub-sections, only a section or sub-section in which an error occurs may be loaded and recovered without loading and recovering the entire firmware during a recovery process. A standard for dividing one firmware or a firmware section into two or more firmware sections or sub-sections may vary according to characteristics and operations of the OS, the mobile terminal, and the like.

The control unit 130 may monitor an operation of firmware installed in the firmware storage unit 151. A process performed by the firmware installation unit 110 to upgrade the firmware of the firmware storage unit 151 may include at least one of, without limitation, a process of booting or rebooting the mobile terminal in which firmware is installed, a process of calling a bootloader for driving a system of the mobile terminal, a process of entering a download mode to upgrade the firmware, and a process of calling a kernel. The control unit 130 may monitor whether the firmware is normally upgraded using a flag in the processes of upgrading the firmware. A flag may be an item of data that may indicate whether a specific state is established when a program is executed. Further, the flag may refer to an indicator assigned to data for the purpose of identification or display. For example, a flag having a size of 1 bit or larger may be used.

When it is determined using a flag that a fault has occurred in the process of upgrading the firmware, the control unit 130 may transmit a firmware recovery signal to the firmware installation unit 110 so that previous firmware, which was normally installed prior to the attempt to upgrade to the new firmware, may be recovered. More specifically, the control unit 130 may identify a section or sections of the new firmware that has to be recovered and upload another copy of the new firmware section or corresponding firmware section of the previously installed firmware to replace the affected section. The control unit 130 may transmit a firmware section recovery signal to the backup storage unit 153 so that the backup storage unit 153 may transmit backup firmware section data for the firmware section in which the fault has occurred to the firmware installation unit 110 to recover the respective firmware section in which the fault has occurred. Although the control unit 130 is described as monitoring an operation of the firmware through a flag, aspects of the invention is not limited thereto, such that the control unit 130 may monitor an operation of the firmware using various methods according to characteristics of the OS, the mobile terminal, or a developer's settings.

The storage unit 150 includes the firmware storage unit 151 and the backup storage unit 153.

Firmware for driving the mobile terminal may be installed by the firmware installation unit 110 and stored in the firmware storage unit 151. When the firmware storage unit 151 receives firmware installation data or firmware recovery data from the firmware installation unit 110, the firmware storage unit 151 may store the received firmware installation data or firmware recovery data therein, and may provide the stored data for upgrading or recovering the firmware.

When the firmware storage unit 151 receives a firmware section backup signal from the control unit 130, the firmware storage unit 151 may transmit firmware section backup data, which may be generated by dividing a copy of the existing firmware to the backup storage unit 153 for storage. The existing firmware may refer to the firmware installed before attempting to upgrade to the new firmware, which may be divided in sections, in the mobile terminal. The firmware section backup data may include two or more firmware sections, which may be obtained by dividing one firmware into two or more firmware sections according to at least one of a unit of operation and a unit of installation. The firmware storage unit 151 may perform a process of backing up a copy of the existing firmware in multiple sections in response to receiving a firmware section backup signal from the control unit 130 before the firmware installation 110 upgrades or installs a section of the existing firmware with a new firmware.

The backup storage unit 153 may store the firmware section backup data received from the firmware storage unit 151. When the backup storage unit 153 receives a firmware section recovery signal from the control unit 130, the backup storage unit 153 may transmit one or more backed-up firmware section data to the firmware installation unit 110 based on the received firmware section recovery signal.

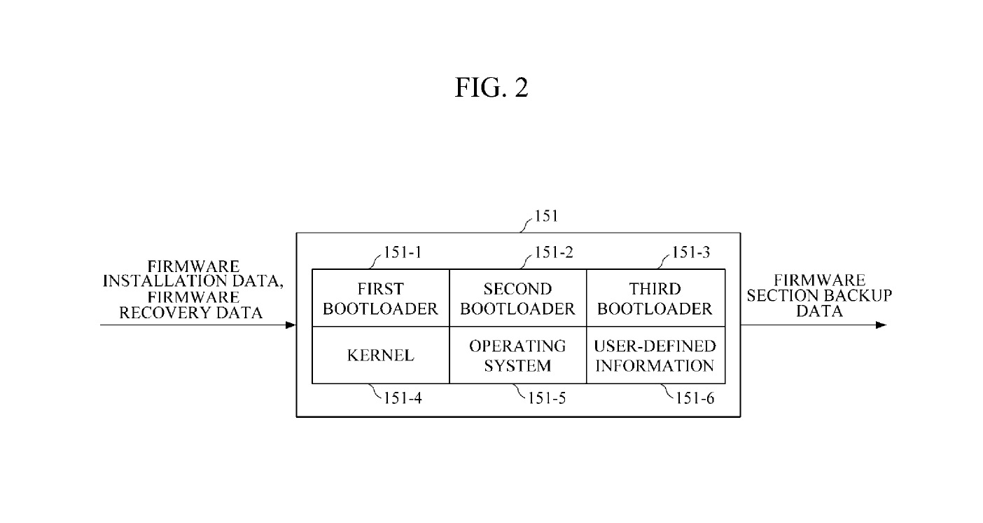

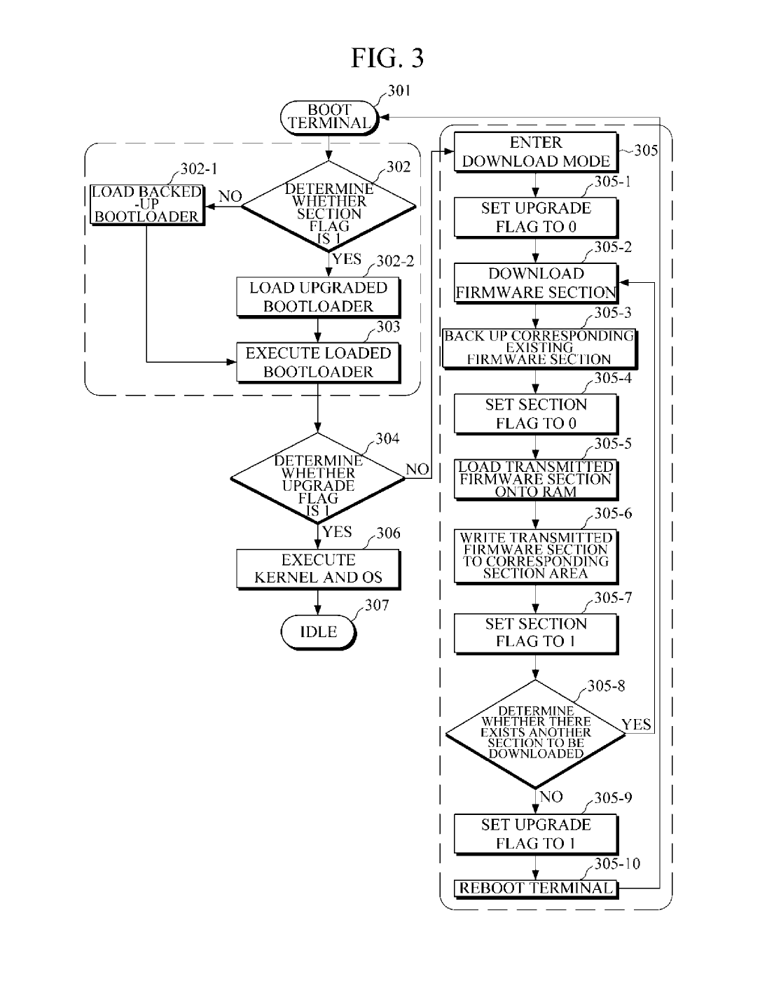

A method for recovering and/or upgrading firmware of a mobile terminal will now be described in more detail with reference to FIG. 2 and FIG. 3.

FIG. 2 is a detailed block diagram illustrating a firmware storage unit of FIG. 1 according to an exemplary embodiment of the present invention.

Referring to FIG. 2, firmware installed and stored in the firmware storage unit 151 of the apparatus of FIG. 1 is divided into two or more firmware sections. A standard for dividing one firmware into two or more firmware sections may be based on at least a unit of operation and a unit of installation. As shown in FIG. 2, a firmware installed in the mobile terminal is divided into a first bootloader section 151-1, a second bootloader section 151-2, a third bootloader section 151-3, a kernel section 151-4, an OS section 151-5, and a user-defined information section 151-6. However, aspects of the invention are not limited thereto, such that the firmware may be divided into a smaller number of sections, a larger number of sections, or a different division of sections. The first bootloader section 151-1, the second bootloader section 151-2, the third bootloader section 151-3, the kernel section 151-4, the OS section 151-5, and the user-defined information section 151-6 may be installed and stored in the firmware storage unit 151. The first bootloader section 151-1, the second bootloader section 151-2, and the third bootloader section 151-3 may be firmware sections obtained by dividing one bootloader section for driving the mobile terminal included in the firmware into three firmware sub-sections. The bootloader section may be divided into sub-sections according to its operation and/or a unit of installation. The kernel section 151-4 may be a firmware section including a kernel layer of an OS, and the OS section 151-5 may be a firmware section including the OS of the mobile terminal. Also, the user-defined information section 151-6 may be a firmware section including information about a user's settings for the firmware and the OS. A firmware may be divided into two or more firmware sections according to at least one of a unit of operation and a unit of installation to generate respective firmware sections. Since one firmware section is divided into two or more firmware sections, only a firmware section in which an error occurs may be reloaded to be recovered without loading to recover unaffected firmware sections during a recovery process. Although a division of a firmware into multiple sections is shown in FIG. 2, aspects of the invention are not limited thereto, such that a firmware may be divided into different sections according to characteristics, units of division, and operations of the OS and/or the mobile terminal.

FIG. 3 is a flowchart illustrating a method for upgrading firmware of a mobile terminal according to an exemplary embodiment of the present invention. The method of FIG. 3 will be described as if performed by the apparatus of FIG. 1, but aspects of the invention are not limited thereto.

Referring to FIG. 1 and FIG. 3, in operation 301, a mobile terminal is booted to upgrade firmware. When upgrading the existing firmware to the new firmware, the new firmware may be installed in a booting process before OS of the mobile terminal is executed.

Once the mobile terminal is booted, the method proceeds to operation 302. In operation 302, the control unit 130 checks a section flag of a bootloader according to firmware installed in the firmware storage unit 151. The section flag, which may be an indicator for determining whether one or more sections of the new firmware has normally installed, may to indicate whether one or more firmware sections of the new firmware has completed a process of downloading and installing without error. The control unit 130 may determine whether one or more sections of the new firmware are normally installed or without error by checking a setting value of the section flag. The setting value of 1 for the section flag corresponding to a firmware section of the new firmware may indicate that upgrading of the respective firmware section has been normally completed or without error. The setting value of other than 1, such as 0, for the section flag corresponding to the firmware section of the new firmware may indicate that the updating of the respective firmware section has not normally completed or has incurred an error. When the section flag indicates that a section of the firmware is not normally installed or has incurred an error, an existing image or copy of a backed-up firmware section, which may be stored in the backup storage unit 153 and corresponding to the firmware section incurring the error, is read or retrieved. Although a method for determining whether a bootloader of a new firmware has been properly loaded using the section flag are shown in FIG. 3, aspects of the invention are not limited thereto, such that other indicators, values, or methods may be used.

More specifically, in operation 302, the control unit 130 may determine whether a bootloader section of the new firmware has normally installed or without error using the section flag. If the control unit 130 determines in operation 302 that the bootloader section of the new firmware has not normally installed or has incurred an error, the method proceeds to operation 302-1. In operation 302-1, an image or a copy of an existing bootloader section, which may be a section of the existing firmware that was installed in the mobile terminal before the attempted upgrade, backed up in the backup storage unit 153 is read. If the control unit 130 determines, using the section flag that the bootloader section, is normally installed or without error, the method proceeds to operation 302-2. In operation 302-2, an image of the bootloader section of the new firmware is read.

In operation 303, a bootloader is executed. The executed bootloader may be a bootloader of the new firmware or a backed-up copy of the existing firmware. When the bootloader of the new firmware is normally loaded or without error, the respective bootloader may be executed. When the bootloader of the new firmware is not normally loaded or installed, the respective bootloader may not normally operate and the bootloader of the existing firmware, which may be backed up or stored in the firmware storage unit 151, may be fetched and loaded. Therefore, even when a bootloader of the new firmware is not normally installed or loaded in a process of installing or upgrading to the new firmware, a bootloader of the existing firmware may be fetched to be loaded and/or executed, thereby making it possible to normally perform a booting process.

Although the control unit 130 checks and executes a bootloader in operation 302 and operation 303, a firmware may be divided into two or more firmware sections according to aspects of the invention. Further, the control unit 130 may not check all of the bootloaders of the new firmware before determining whether all of the backed-up bootloaders of the existing firmware are to be used, but instead may check flags of individual bootloader sections and determine whether to use the backed-up bootloader section corresponding to the corrupted bootloader section, which may be the bootloader section that incurred an error, of the new firmware. Accordingly, instead of replacing all bootloader sections of the new firmware with all bootloader sections of the existing firmware, the control unit 130 may retain a bootloader section of the new firmware that has normally downloaded, loaded, installed, or executed and fetches a backed-up bootloader section of the existing firmware only for a bootloader section that has not normally downloaded, loaded, installed, or executed.

In operation 304, the control unit 130 checks to determine a value of an upgrade flag. The upgrade flag may be an indicator for determining whether the new firmware has been loaded, installed or executed normally or without error. More specifically, the upgrade flag may indicate that a process of upgrading the firmware or installing of the new firmware to replace the existing firmware has normally completed. The section flag may indicate whether one or more bootloader sections corresponding to a bootloader of the new firmware has normally upgraded in a process of upgrading firmware, whereas the upgrade flag may determine whether an overall process of upgrading firmware is completed or whether all of the firmware sections of the new firmware has installed without error. However, aspects of the invention are not limited thereto, such that the section flag may indicate whether other firmware sections have normally downloaded, loaded, installed, and executed in the process of upgrading firmware. The control unit 130 may determine whether the new firmware has to be re-downloaded, reloaded, reinstalled or re-executed based on the set value of the upgrade flag. When the upgrade flag is set to 1, it may indicate that the process of upgrading the firmware or installing the new firmware has normally completed or without error. When the upgrade flag is set to a value other than 1, such as 0, it may indicate that the new firmware, or at least a section of the new firmware, has to be upgraded again. Although a method for determining whether the new firmware has to be upgraded again using the upgrade flag are shown in FIG. 3, aspects of the invention are not limited thereto, such that other indicators, values, or methods may be used. For example, repeating the upgrade process may include, at least one of, without limitation, at least one of re-downloading, reloading, reinstalling and/or re-executing one or more sections of the new firmware.

When the control unit 130 determines in operation 304, using the upgrade flag, that the new firmware has to be upgraded, the method proceeds to operation 305. In operation 305, the control unit 130 enters a download mode to perform a process of re-upgrading the new firmware. The download mode may be a mode in which a process of re-downloading, reloading, and/or reinstalling one or more sections of the new firmware data.

In operation 305-1, in the download mode, the upgrade flag is set to 0 in response to a determination in operation 304. When the upgrade flag is set to 0, the control unit 130 may determine that one or more sections of the new firmware have to be re-upgraded. More specifically, when the upgrade flag is set to 0 and not 1, the control unit 130 may determine that the new firmware has to be re-downloaded, reloaded, reinstalled, and/or re-executed.

In operation 305-2, the control unit 130 downloads a section of the new firmware. The downloaded firmware section may be loaded and/or installed over a corresponding section of the existing firmware according to a division of the firmware sections, which may be divided according to at least one of a unit of operation and a unit of installation.

In operation 305-3, a firmware section of the new firmware corresponding to a firmware section of the existing firmware among the two or more firmware sections of the existing firmware, which may be backed up in the backup storage unit 153. When a problem occurs when a section of the new firmware is being downloaded, or a fault occurs in the process of installing the respective section of the new firmware, such as an error in the mobile terminal or low power of the mobile terminal, the respective firmware section of the new firmware may be damaged. In particular, when a firmware section of the new firmware, which may be used to boot the mobile terminal, such as a bootloader, is damaged or corrupted, the mobile terminal may no longer be usable unless a replacement or substitute bootloader or firmware section is available. Accordingly, before the firmware section of the new firmware is upgraded or installed, one or more firmware sections of the existing firmware corresponding to the firmware sections of the new firmware may be backed up and stored in the backup storage unit 153.

In operation 305-4, the section flag is set to 0. The section flag may be an indicator used for determining whether installation of one or more firmware sections is normally completed or without error. When the upgrading of the respective firmware section of the new firmware having a section flag of 0 is normally completed or without error, the section flag is changed to be set to 1. When the upgrading of the firmware section of the new firmware is not normally completed, the section flag may maintain a set value of 0, and the control unit 130 may determine in operation 302 that the firmware section of the new firmware has not normally installed or without error based on the set value of the section flag. Accordingly, in operation 302, the control unit 130 may determine that there is a problem in the firmware section based on the section flag, which may be set to 0.

In operation 305-5, a firmware section of the new firmware, which is downloaded in operation 305-2, is loaded onto a random access memory (RAM). In operation 305-6, the downloaded firmware section of the new firmware is written to a corresponding section of the existing firmware. Accordingly, an existing firmware section corresponding to the firmware section of the new firmware is upgraded. More specifically, a section of the new firmware is downloaded in operation 305-3, loaded in operation 305-5, and installed over the corresponding section of the existing firmware in operation 305-6.

In operation 305-7, the section flag set to 0 in operation 305-1 is set to 1. From operation 305-1 to operation 305-6, upgrading of a firmware section of the new firmware is performed. When the section flag is set to 1, the control unit 130 may determine in operation 302 that the respective firmware section of the new firmware is normally upgraded.

In operation 305-8, it is determined whether there are firmware sections of the new firmware that remains to be upgraded or installed. When upgrading firmware of the mobile terminal, the respective firmware may be upgraded in sections. More specifically, the firmware of the mobile terminal may be divided into two or more firmware sections. Accordingly, one or more firmware sections among the available firmware sections may be upgraded without having to upgrade all of the firmware sections. When there exists an additional firmware section of the new firmware that is to be upgraded or installed, the method returns to operation 305-2 in which another firmware section of the new firmware is downloaded for installation. One or more firmware sections may be upgraded at a time. When two or more firmware sections are to be upgraded, the firmware sections may sequentially be upgraded or installed one by one according to a result of the determination in operation 305-8.

When it is determined in operation 305-8 that there are no more firmware sections to be upgraded or installed, the method proceeds to operation 305-9. In operation 305-9, the upgrade flag is set to 1. When the upgrade flag is changed to be set to 1 in operation 305-9, the control unit 130 may determine in operation 304 that upgrading of the firmware is completed and determine that no additional firmware section has to be upgraded when the mobile terminal is rebooted to perform the method of FIG. 3 again.

When all of firmware sections of the new firmware are installed, the method proceeds to operation 305-10. In operation 305-10, the download mode ends and the mobile terminal is rebooted in operation 305-10 to complete the upgrading of the firmware. After a new firmware section is downloaded and upgraded, the mobile terminal is rebooted to apply newly installed firmware to the mobile terminal. The rebooted mobile terminal performs the method of FIG. 3 beginning from operation 301. In operation 302, the rebooted mobile terminal determines whether upgrading of each firmware section is normally completed using setting values of the section flag and the upgrade flag set in the download mode of operation 305. When it is determined in operation 302 that the upgrading is not normally completed, the method proceeds to operation 302-1. In operation 302-1, a backed-up firmware section of the existing firmware corresponding to the corrupted firmware section of the new firmware is loaded. Therefore, even when an error may occur in a specific firmware section, the mobile terminal may be normally booted to enter the download mode through operation 305 based on a determination in operation 304, and perform a process of upgrading one or more sections of the new firmware again by obtaining one or more replacement firmware sections to replace one or more corrupted firmware sections.

In the download mode of operation 305, existing firmware sections corresponding to all firmware sections of the new firmware are backed up and stored, and the installed firmware sections are upgraded with the new firmware. However, when the mobile terminal is rebooted but the bootloader of the new firmware fails to be executed, the mobile terminal may retrieve the bootloader of the previous firmware and enter the download mode through operation 304, such that a replacement firmware section may be obtained and installed. Accordingly, even when firmware sections that may be executed before operation 304 become damaged in an upgrading process, the mobile terminal may still enter the download mode. Accordingly, operations of backing up existing firmware sections and setting the section flags for the firmware sections excluding the bootloader section and the other essential sections may be omitted.

When the set value of the upgrade flag in operation 304 is determined to be 1, it is determined that upgrading of overall firmware is normally completed or without error. In operation 306, execution of a firmware section, such as a kernel or an OS, is completed. In operation 307, the mobile terminal returns to an initial idle state.

In the method of FIG. 3, a process of performing operations 302, 302-1, 302-2, and 303, and 305 in which a bootloader firmware section of the existing firmware is backed up and recovered is illustrated. Although, not illustrated, a process of performing operations in which a kernel firmware section and an OS firmware section may be separately backed up and recovered. Such process may be performed after operation 305 in which the mobile terminal enters the download mode. Further, although only a bootloader firmware section is backed up and recovered in operations 302, 302-1, 302-2, and 303, and 305, aspects of the invention are not limited thereto, such that operations 302, 302-1, 302-2, 303, and 305 of performing backup and recovery may performed on a variety firmware sections that may be executed prior to operation 305 in which the mobile terminal enters the download mode. More specifically, when a kernel and an OS are to be executed prior to operation 305 in which the mobile terminal enters the download mode, operations 302, 302-1, 302-2, 303, and 305 of performing backup and recovery may be performed on a kernel firmware section and an OS firmware section. When the kernel and the OS are executed and the mobile terminal enters the download mode in operation 305, flags may become set for the kernel firmware section and the OS firmware section. Further, a determination of whether to recover the kernel firmware section and the OS firmware section may be made by determining whether the kernel firmware section and the OS firmware section are normally installed according the set values for the section flag and/or the upgrade flag.

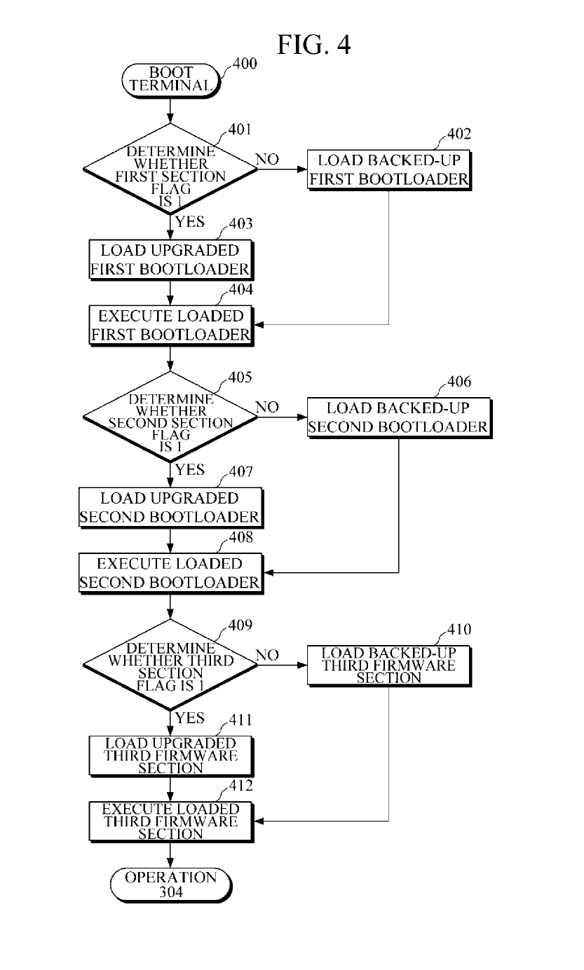

FIG. 4 is a flowchart illustrating a booting process of FIG. 3 according to an exemplary embodiment of the present invention. The booting process of FIG. 4 will be described with respect to method of FIG. 3, but aspects of the invention are not limited thereto.

Referring to FIG. 3 and FIG. 4, the booting process in method of FIG. 3 may include operations 301 through 303 of the method of FIG. 3. In the booting process, it may be determined whether a firmware section corresponding to each of one or more section flags is normally upgraded using a setting value of the section flag.

The mobile terminal is booted in operation 400. In operation 401, a determination of the setting value of a first section flag is made. If it is determined that the setting value of the first section flag corresponding to a first bootloader of the new firmware is 1, the control unit 130 may determine that the first bootloader of the new firmware was normally loaded or loaded without incurring an error.

When it is determined in operation 401 that the setting value of the first flag section is not 1, such as 0, the booting process proceeds to operation 402. In operation 402, a backed-up first bootloader or first bootloader of the existing firmware is loaded. When the setting value of the first flag section is not 1, such as 0, it may indicate that the first bootloader of the new firmware corresponding to the first section flag may not be normally upgraded, downloaded, loaded, installed, or executed. Accordingly, it may be determined that an error has occurred in the first bootloader of the new firmware, and the first bootloader of the existing firmware, which may have been backed up in operation 305-3 of FIG. 3, is loaded again.

When it is determined that the setting value of the first section flag is 1, the booting process proceeds to operation 403. In operation 403, an upgraded first bootloader or first bootloader of the new firmware is loaded. When the setting value of the first section flag is 1, it may indicate that the first bootloader corresponding to the first flag section is normally upgraded. Accordingly, the first bootloader whose upgrading is completed is loaded.

In operation 404, the loaded first bootloader is executed. The first bootloader, which may be the upgraded first bootloader or the backed-up first bootloader, is loaded according to the setting value of the first section flag and executed. Therefore, the first bootloader may be normally loaded and executed irrespective of whether an error occurs in the first bootloader of the new firmware when upgrading, which may include downloading, loading, installing, and/or executing, the first bootloader of the new firmware.

When the first bootloader of the new firmware is normally executed, the booting process proceeds to operation 405. In operation 405, a determination of the setting value of a second section flag is made. If it is determined that the setting value of the second section flag is 1.

When it is determined in operation 405 that the setting value of the second flag section is not 1, such as 0, the booting process proceeds to operation 406. In operation 406, a backed-up second bootloader or second bootloader of the existing firmware is loaded. When the setting value of the second flag section is not 1, such as 0, it may indicate that upgrading of a second bootloader of the new firmware corresponding to the second section flag may not be normally downloaded, loaded, installed, and/or executed. Accordingly, it may be determined hat an error has occurred in the second bootloader of the new firmware, and the second bootloader of the existing firmware, which may have been backed up in operation 305-3 of FIG. 3, is loaded again. The second bootloader may be a firmware section from among two or more bootloader sections for driving the mobile terminal, and may be executed after the first bootloader.

When it is determined in operation 405 that the setting value of the second section flag is 1, the booting process proceeds to operation 407. In operation 407, an upgraded second bootloader or second bootloader of the new firmware is loaded. When the setting value of the second section flag is 1, it may indicate that the upgrading of the second bootloader corresponding to the second flag section is normally completed. Accordingly, the second bootloader whose upgrading is completed is loaded.

In operation 408, the loaded second bootloader is executed. The second bootloader, which may be the upgraded second bootloader or the backed-up second bootloader, is loaded according to the setting value of the first section flag and executed. Therefore, the second bootloader may be normally loaded and executed irrespective of whether an error occurs in the second bootloader of the new firmware when upgrading, which may include downloading, loading, installing, or executing, the second bootloader of the new firmware.

When the second bootloader of the new firmware is executed, the booting process proceeds to operation 409. In operation 409, a determination of the setting value a third section flag is made. If it is determined that the setting value of the third section flag is 1.

When it is determined in operation 409 that the setting value of the third section flag is not 1, such as 0, it is determined that the third firmware section is damaged and the booting process proceeds to operation 410. In operation 410, a backed-up third firmware section or third firmware section of the existing firmware is loaded. When it is determined in operation 409 that the setting value of the third section flag is 1, the booting process proceeds to operation 411. In operation 411, an upgraded third firmware section or the third firmware of the new firmware is loaded. In operation 412, the loaded third firmware is executed. The third firmware section may be a firmware section that is executed in the booting process, and executed after the first bootloader and the second bootloader. Further, the third firmware section may be a firmware section that may be executed prior to operation 305 in which the mobile terminal enters the download mode in the booting process according to a manufacturer's design.

A determination of whether a firmware section is normally upgraded, which may include downloading, loading, installing, or executing the firmware section, may be determined using setting values of a section flag. For example, a determination of whether the first bootloader, the second bootloader, and the third firmware section is normally upgraded or without error may be determined using the setting values of the first section flag, the second section flag, and the third section flag. When it is determined that there is an error, a backed-up firmware section of the existing firmware may be loaded and/or used. Therefore, even when an error occurs in a firmware section while upgrading firmware, the mobile terminal may enter a download mode for obtaining a firmware section of the new firmware corresponding to the corrupted firmware section. Accordingly, the mobile terminal may face less risk from becoming unusable due to an error that may occur in the process of upgrading the firmware. Although three section flags and three bootloaders and firmware sections were described in FIG. 4, aspects of the invention are not limited thereto, such that a bootloader section or a firmware section may be divided into a various number of bootloader sub-sections or firmware sub-sections according to manufacturer design, and the number of section flags may be set based on the number of the bootloaders.

According to aspects of the invention, even when a critical error occurs in a smart device or a mobile terminal due to an unexpected fault occurring during a process of upgrading firmware, a backed-up bootloader may be loaded or used to normally boot the mobile terminal such that the process of upgrading the firmware may be performed again.

The exemplary embodiments of the present invention can be embodied or implemented as computer-readable codes on a computer-readable record medium. The computer readable record medium may include various types of record media in which computer readable data are stored. Examples of the computer readable record medium may include, without limitation, a read-only memory (ROM), a random-access memory (RAM), a compact-disc read-only memory (CD-ROM), a magnetic tape, a floppy disk, and an optical data storage devices. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for upgrading firmware of a mobile terminal having a processor, the method comprising:
dividing, using the processor, a first firmware into a plurality of first firmware sections;
storing a copy of at least one of the first firmware sections in the mobile terminal;
loading a second firmware divided into a plurality of second firmware sections;
determining whether at least one of the second firmware sections has incurred an error; and
loading the stored copy of the first firmware section corresponding to the second firmware section if the second firmware section is determined to have incurred an error.

2. The method of claim 1, wherein the second firmware section is used for booting the mobile terminal.

3. The method of claim 1, wherein the second firmware section is a bootloader of the second firmware.

4. The method of claim 1, wherein the first firmware section or the second firmware section is divided into a plurality of first firmware sub-sections or second firmware sub-sections, respectively.

5. The method of claim 1, wherein the first firmware is divided according to at least one of a unit of operation and a unit of installation.

6. The method of claim 1, wherein the second firmware section is determined to have incurred an error based on a value of a corresponding section flag.

7. The method of claim 6, wherein the value of the section flag is set to a first value when the second firmware section is determined to have incurred an error.

8. The method of claim 7, wherein the value of the section flag is changed to a second value when the second firmware section that has incurred an error is replaced with a corresponding replacement second firmware section.

9. The method of claim 1, wherein the first firmware is installed in the mobile terminal before the second firmware.

10. The method of claim 1, further comprising:
executing the first firmware section or the second firmware section for executing at least one of a kernel and an operating system of the mobile terminal.

11. A method for upgrading firmware of a mobile terminal having a processor, the method comprising:
dividing, using the processor, a first firmware into a plurality of first firmware sections;
storing a copy of at least one of the first firmware sections in the mobile terminal;
upgrading the first firmware with a second firmware, the second firmware divided into a plurality of second firmware sections;
determining whether an error occurs when upgrading; and
replacing at least one of the second firmware sections having an error with a corresponding replacement second firmware section if an error is determined to have occurred.

12. The method of claim 11, wherein the determination of whether an error has occurred is based on a value of an upgrade flag.

13. The method of claim 12, wherein the value of the upgrade flag is set to a first value when at least one of the second firmware sections is determined to have an error.

14. The method of claim 13, wherein the value of the upgrade flag is changed to a second value when the second firmware section having an error is replaced with a corresponding replacement second firmware section.

15. The method of claim 11, wherein the replacing at least one of the second firmware sections comprises:
identifying the second firm section having an error;
downloading the replacement second firmware section corresponding to the second firmware section having an error;
backing up a first firmware section corresponding to the second firmware section having an error;
loading the replacement second firmware section for installation; and
installing the replacement second firmware section.

16. The method of claim 11, wherein the upgrading with the second firmware comprises at least one of downloading, loading, installing and executing at least one of the second firmware sections.

17. An apparatus to upgrade firmware of a mobile terminal having a processor, the apparatus comprising:
a control unit to divide a first firmware into a plurality of first firmware sections;
a storage unit to store a copy of at least one of the first firmware sections, and to store a second firmware divided into a plurality of second firmware sections; and
a management unit to load at least one of the second firmware sections, to determine whether the loaded second firmware section incurred an error, and to load the stored copy of the first firmware section corresponding to the second firmware section if the second firmware section is determined to have incurred an error.

18. The apparatus of claim 17, wherein the second firmware is downloaded through a wired or wireless connection, and the first firmware is installed in the mobile terminal before the second firmware.

19. The apparatus of claim 17, wherein the management unit determines whether the second firmware section incurred an error based on a value of a corresponding section flag.

20. The apparatus of claim 17, wherein the management unit upgrades at least one of the first firmware section with a second firmware section, determines whether an error has occurred during the upgrade, and replaces at least one of the second firmware sections having an error with a corresponding replacement second firmware section if an error is determined to have occurred.

21. The apparatus of claim 20, wherein a determination of whether an error has occurred during the upgrade is based on a value of an upgrade flag.

22. The apparatus of claim 17, wherein the management unit executes the first firmware section or the second firmware section for executing at least one of a kernel and an operating system of the mobile terminal.
